(19) United States
(12) Patent Application Publication
(10) Pub. No.: US 2020/0097148 A1
(43) Pub. Date: Mar. 26, 2020

(54) SYSTEM FOR GENERATING MULTIPLE-COMMAND MACROS

(71) Applicant: Bank of America Corporation, Charlotte, NC (US)

(72) Inventors: Geetu N. Arora, Harrisburg, NC (US); Ajay S. Puraswani, Charlotte, NC (US)

(21) Appl. No.: 16/141,305

(22) Filed: Sep. 25, 2018

(51) Int. Cl. G06F 3/0484

(52) U.S. Cl. CPC G06F 3/0484; G06F 9/451

(57) ABSTRACT

A system for generating and executing a multiple-command macro is disclosed. A macro processing server of the disclosed system receives a request from a user to generate a multiple-command macro based on user interaction sessions. Each of the user interaction sessions includes multiple commands from users and multiple responses from a server. The multiple-command macro is generated as including the multiple commands such that the multiple commands are demarcated from the responses of the user interaction sessions.

### TECHNICAL FIELD

This disclosure relates generally to reducing network bottlenecks, and more particularly to a system for generating multiple-command macros.

### BACKGROUND

Enterprises receive a significant number of web requests from users on a daily basis. The web requests usually require frequent access to the databases of the enterprises. For example, the web requests may include queries sent to the databases over a network. Sending numerous queries to the databases of the enterprises over the network consumes a significant amount of network bandwidth. This creates a significant strain on the network and may lead to network bottlenecks. Furthermore, frequently accessing the databases of the enterprise involves caching data elements that are stored in the databases. Frequently caching the data elements that are stored in the databases leads to a large amount of read and write operations on the memory space of the databases. This places a burden on the memory space of the databases, thereby reducing the processing speed of a computer system that implements the databases and degrading the performance of the computer system. It may also lead to the corruption of the memory space over time.

Therefore, it is desirable to provide a solution that is directed to addressing the above-discussed technical issues with existing systems.

### SUMMARY

Enterprises receive a significant number of web requests from users on a daily basis. The web requests that the users send to the web server of the enterprises include routine requests that the users send to the web server regularly. For example, a user may send the same series of web requests to the web server to perform some routine tasks every week or month. In response to the web requests, the enterprises also receive a significant number of responses from a web server that processes the requests. User interaction sessions comprising these routine requests and the responses include a significant amount of data that are repeatedly transmitted between the users and the web server over the network. The large volume of data transmitted over the network creates a significant strain on the network. Furthermore, storing such large volume of data places a great burden on the memory space of the underlying computer system.

The present disclosure discloses a system to address the above-discussed network problems and memory burdens of the computer system. Specifically, the disclosed system discloses generating multiple-command macros. A multiple-command macro disclosed in the present disclosure includes a series of commands from a user. The user may send a web request to the web server to play the macro and execute the commands in the macro. In this way, the user does not need to send multiple web requests for the many commands to the web server. Sending a single web request of the macro instead of many web requests of the commands to the web server reduces the number of web requests that are transmitted over the network. This facilitates reducing the strain on the network and alleviates the network bottlenecks. Furthermore, the disclosed system creates the macros such that only the requests are recorded in the macro and the responses are not recorded in the macro. Responses from the web servers may differ for a same command within different user sessions. Therefore, storing the responses in the macros is not necessary and it requires more memory space for storing the responses. The disclosed system demarcates the responses from the commands when creating the macros. This facilitates conserving the memory space of the underlying computers, thereby improving the performance of the computers and the overall system.

In one embodiment, the disclosed system performs a plurality of user interaction sessions. Each of the user interaction sessions includes a series of commands and a series of responses to the series of commands. In conjunction with performing a first user interaction session, the system receives a first request to generate a first command macro for the first user interaction session. The first user interaction session includes a first series of commands and a first series of responses. After receiving the first user interaction session including the first series of commands and the first series of responses, the system records the first series of commands such that the first series of commands are separated from the first series of responses. Then, the system links together the first series of commands in sequence based on their timestamps and generates the first command macro including the linked first series of commands. The system further stores the first command macro in the memory.

By generating a macro that includes a series of commands, the system only needs to send a single web request of the macro instead of many web requests of the separate commands to a web server over the network. This approach reduces the number of web requests that are transmitted over the network, thereby facilitating reducing the strain on the network and alleviating the network bottlenecks. Furthermore, this approach only stores the commands in the macros but not the responses. This uses less memory space of the system, thereby reducing burden on the memory space and improving the performance of the computer and the overall system.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 illustrates an exemplary embodiment of a system for generating multiple-command macros, according to the present disclosure;

FIG. 2 illustrates a table presenting an exemplary embodiment of a user interaction session for recording a multiple-command macro;

FIG. 3 illustrates a table presenting an exemplary embodiment of a user interaction session for playing a multiple-command macro, according to the present disclosure;

FIG. 4 illustrates an exemplary embodiment of a method of generating a multiple-command macro, according to the present disclosure; and

FIG. 5 illustrates an exemplary embodiment of a method of playing a multiple-command macro, according to the present disclosure.

### DETAILED DESCRIPTION

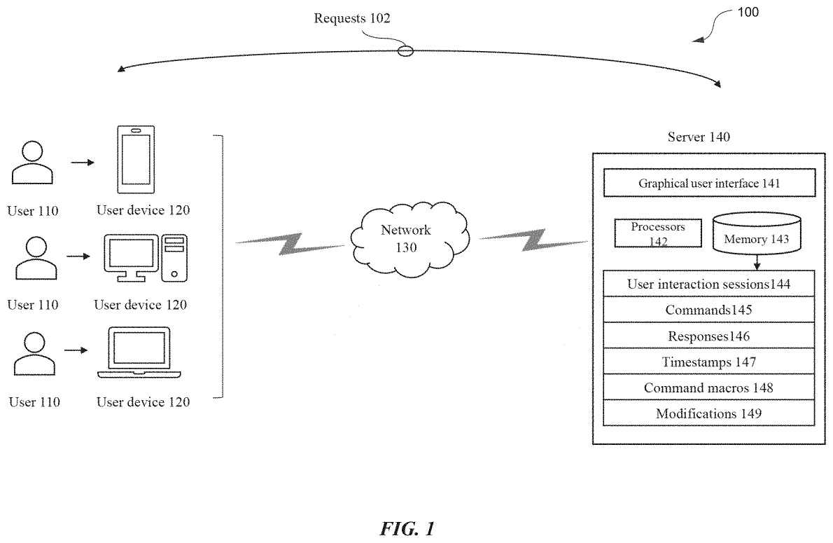

FIG. 1 illustrates an exemplary embodiment of a system 100 for processing multiple-command macros, according to certain embodiments of the present disclosure. System 100 includes one or more user devices 120, a network 130, and a macro processing server 140.

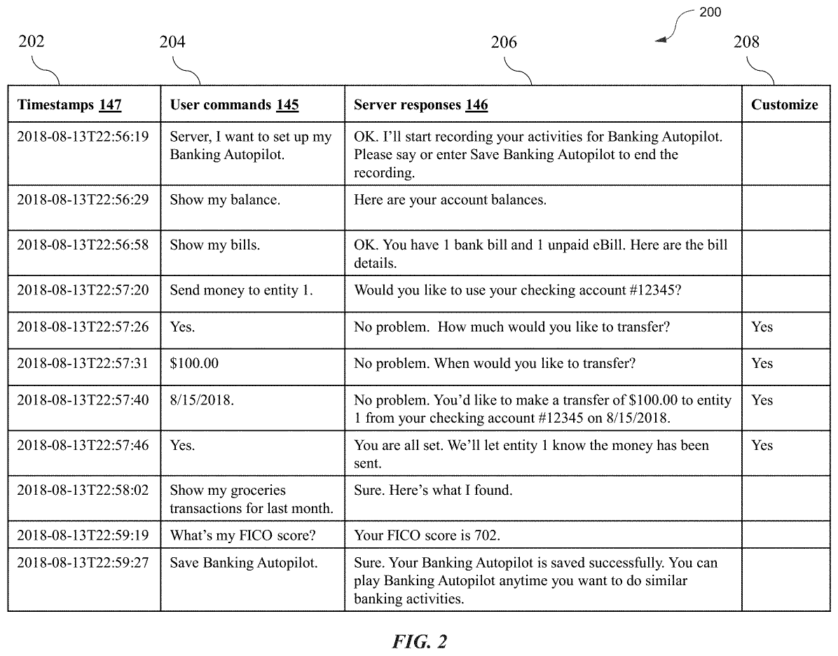

In general, system 100 can receive requests 102 from users 110 for generating multiple-command macros 148 based on user interaction sessions 144 at server 140. Each of the user interaction sessions 144 includes multiple commands 145 from users 110 and multiple responses 146 from the server 140. The multiple-command macros 148 are generated as including the multiple commands 145 such that the multiple commands 145 are demarcated from the responses 146 of the user interaction sessions 144. This process is described below in greater detail with reference to FIGS. 2-5. In one embodiment, the user interaction sessions 144 are performed in conjunction with a chatbot or other artificial intelligence conversational entity implemented by server 140. In this embodiment, for example, server 140 is configured to execute a chatbot application that communicates with and responds to users 110, as described in greater detail below.

Users 110 comprise any suitable users including businesses or other commercial organizations, government agencies, and/or individuals. Users 110 may operate on one or more user devices 120 to access system 100.

User devices 120 comprise any suitable devices or machines configured to communicate with other network devices in the system 100. Typically, user device 120 is a data processing system comprising hardware and software that communicates with the other network elements over a network, such as the Internet, an intranet, an extranet, a private network, or any other medium or link. These data processing systems typically include one or more processors, an operating system, one or more applications, and one or more utilities. Applications running on the data processing systems provide native support for web protocols including, but not limited to, support for Hypertext Transfer Protocol (HTTP), Hypertext Markup Language (HTML), and Extensible Markup Language (XML), among others. Examples of user devices 120 include, but are not limited to, desktop computers, mobile phones, tablet computers, and laptop computers.

Network 130 includes any suitable networks operable to support communication between components of system 100. Network 130 may include any type of wired or wireless communication channel capable of coupling together computing nodes. Network 130 may include any interconnecting system capable of transmitting audio, video, electrical signals, optical signals, data, messages, or any combination of the preceding. Network 130 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components of system 100. Network 130 may be configured to support any communication protocols as would be appreciated by one of ordinary skill in the art upon viewing this disclosure.

Macro processing server 140 is a special purpose computer to process multiple-command macros 145. Specifically, macro processing server 140 is configured to generate and play the multiple-command macros 145 based on user interaction sessions 144 as described in greater detail below with reference to FIGS. 2-5. In some embodiments, macro processing server 140 comprises a graphical user interface (GUI) 141, one or more processors 142, and a memory 143.

GUI 141 is generally operable to tailor and filter data entered by and presented to users 110. GUI 141 may comprise a plurality of displays having interactive fields, pulldown lists, and buttons operated by users 110. GUI 141 may include a plurality of groupings and boundaries. It should be understood that the term GUI 141 may be used in the singular or in the plural to describe one or more GUIs 141 and each of the displays of a particular GUI 141.

Processor 142 described in the present disclosure may comprise any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 142 may be a programmable logic device, a microcontroller, a microprocessor, or any suitable combination of the preceding. The processor 142 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

Memory 143 described in the present disclosure may comprise any device operable to store, either permanently or temporarily, data, operational software, or other information for a processor. In some embodiments, the memory 143 comprises one or more disks, tape drives, or solid-state drives, and may be used as an over-flow data storage device, to store programs when such programs are selected for execution, and to store instructions and data that are read during program execution. The memory 143 may comprise any one or a combination of volatile or non-volatile local or remote devices suitable for storing information. For example, the memory 143 may comprise random access memory (RAM), read only memory (ROM), magnetic storage devices, optical storage devices, semiconductor storage devices, or any other suitable information storage device or a combination of these devices.

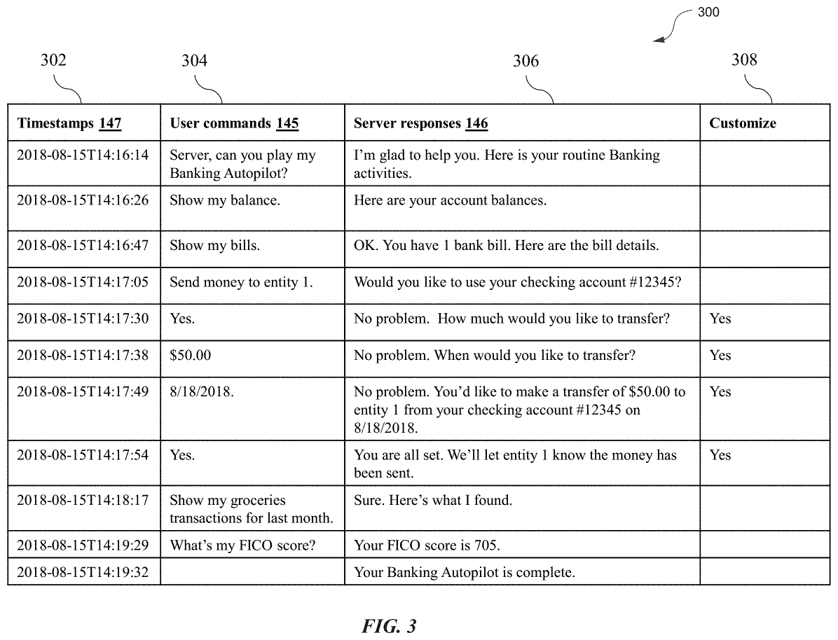

As illustrated in FIG. 1, memory 143 is configured to store user interaction sessions 144, commands 145, responses 146, timestamps associated with the commands 145 and the responses 146, and multiple-command macros 148. User interaction sessions 144 include activities performed by users 110 that are interactions with the server 140 during a specified period of time. Each of the user interaction sessions 144 includes a series of commands 145 sent by a user 110 and a series of responses 146 replied by the server 140 in response to the series of commands 145. FIG. 2-3 illustrates some exemplary embodiments of user interaction sessions 144. Specifically, FIG. 2 illustrates a table 200 presenting an exemplary embodiment of a user interaction session 144 for recording a multiple-command macro 148, and FIG. 3 illustrates a table 300 presenting an exemplary embodiment of a user interaction session 144 for playing a multiple-command macro 148.

Referring to FIG. 2, table 200 is configured with a first column 202 that includes the timestamps 147 associated with the commands 145, a second column 204 the includes the commands 145 sent by the user 110, a third column 206 that includes the responses 146 sent by the server 140 in response to the commands 145, and a fourth column 208 that identifies users commands 145 that may be customizable from one user interaction session 144 to the next. Starting with the earliest timestamp 147 in the column 202 of the table 200, a user 110 sends a first command 145 as a request 102 to generate a multiple-command macro 148, for example such as “Banking Autopilot.” The command 145 sent by the user 110 may have a text format or a voice format. In some embodiments where the commands 145 have voice formats, the server 140 may use a natural language processing (NLP) technique to understand the meaning of the voice command 145. In a particular embodiment configured to implement the “Banking Autopilot,” server 140 uses a chatbot application, such as an artificial intelligence computer program designed to simulate how a human would behave as a conversational partner, to conduct a user interaction session 144 via auditory or textual communications. In response to the command 145 to generate the macro 148, the server 140 sends a response 146 to the user 110 to confirm and start recording the following commands 145 from the user 110 in the macro 148. Similar to the commands 145, the responses 146 provided by the server 140 may be also in the format of text or voice.

Then, the user 110 sends a second command 145 to the server 140, for example such as “show my balance.” In response to the second command 145, the server 140 replied with a second response 146. For example, the server 140 may play (e.g., display or speak) the account balances for the user 110. After receiving the second response 146 from the server 140, the user 110 sends another command 145, for example such as “show my bills.” In response to the third command 145, the server 140 replied with a third response 146. For example, the server 140 may play (e.g., display or speak) the outstanding bills for the user 110. The user 110 further sends other commands 145 to the server 140 and receives responses 146 from the server 140 until the user 110 provides a signal to conclude recording the commands 145 in the macro 148. For example, the user 110 sends a command 145, for example such as “save Banking Autopilot,” to the server as a request 102 to end recording the commands 145 and to save the recorded commands 145 in the macro 148 “Banking Autopilot.”

In some embodiments, server 140 may only record key commands 145 from the user interaction session 144 into the macro 148. For example, among the commands 145 in column 204 of table 200, a subset of the commands 145, for example such as “show my balance,” “show my bills,” “send money to entity 1,” “show my grocery transactions for last month,” and “what's my FICO score?” are recorded in the macro 148 “Banking Autopilot.” The other commands 145 in column 204, for example such as the money amount and transfer date provided by the user 110, are not recorded in the macro 148 “Banking Autopilot” because such commands 145 may differ in different user interaction sessions 144. In this regard, these commands 145 may be customizable by the user 110 and change from one session 144 to the next. Column 208 of table 200 identifies which user commands 145 can be customized from one session 144 to the next and are therefore not recorded in the macro 148. Storing these customizable commands 145 in the macros 148 is unnecessary and requires extra memory space for storage. As such, the multiple-command macro 148 “Banking Autopilot” as generated from the user interaction session 144 represented by table 200 may include the commands 145 “show my balance,” “show my bills,” “send money to entity 1,” “show my grocery transactions for last month,” and “what's my FICO score?” Note that each of the commands 145 in the macro 148 is associated with a timestamp 147. When generating the macro 148, the commands 145 are linked together in sequence based on their timestamps 147. The generated macros 148 are subsequently stored in the memory 143 of the server 140.

As such, the server 140 demarcates the commands 145 from the responses 146 when creating the macros 148 and stores only the commands 145 in the macros 148. The responses 146 from the server 140 may differ within different user interaction sessions 144. For example, when contemplating a response 146 to the command 145 “show my bills,” the server 140 may provide different sets of bills for the user 110 within different user interaction sessions 144 associated with different time periods. Therefore, storing the responses 146 in the macros 148 is unnecessary and requires extra memory space for storage. Storing only the commands 145 in the macros 148 facilitates conserving the memory space of the computers, thereby improving the performance of the computers and the overall system.

FIG. 3 illustrates a table 300 presenting an exemplary embodiment of a user interaction session 144 for playing a multiple-command macro 148. Table 300 is configured with a first column 302 that includes the timestamps 147 associated with the commands 145, a second column 304 the includes the commands 145 sent by the user 110, a third column 306 that includes the responses 146 sent by the server 140 in response to the commands 145, and a fourth column 308 that identifies users commands 145 that may be customizable from one user interaction session 144 to the next.

Starting with the earliest timestamp 147 in the column 302 of the table 300, a user 110 sends a command 145 as a request 102 to play a multiple-command macro 148 that is stored in the memory 143 of the server 140, for example such as “Banking Autopilot.” The server 140 sends a response 146 to the user 110 to confirm and start playing the commands 145 of the macro 148 in sequence based on their timestamps 147. Then, the server 140 starts playing the first command 145 in the macro 148, for example such as “show my balance.” Note that the command 145 “show my balance” in column 304 is retrieved by the server 140 from the memory 143 instead of being sent by the user 110. In response to the command 145, the server 140 provides a response 146. For example, the server 140 may play (e.g., display or speak) the account balances for the user 110. After providing the response 146 to the first command 145 in the macro 148, the server 140 plays a subsequent command 145 in the macro 148, for example such as “show my bills.” In response to the subsequent command 145, the server 140 provides another response 146. For example, the server 140 may play (e.g., display or speak) the outstanding bills for the user 110. The server 140 further plays other commands 145 and provides responses 146 until the last command 145 of the macro 148 is played and a response 146 is provided for the last command 145. For example, the server 140 plays a last command 145, for example such as “what's my FICO score,” and provides a response 146 to the last command 145 that shows the current credit score of the user 110. The server 140 may further provide a response 146 to the user 110 indicating that the macro 148 has been played to the end.

In some embodiments, when the server 140 plays the commands 145 of a macro 148, the user 110 may interrupt the execution of the macro 148 and provide one or more additional commands 145. For example, when playing the command 145 “send money to entity 1” of column 304, the user 110 may provide a command 145 that indicates an amount of money that will be transferred to another entity. This command 145 may include a modification to a corresponding command 145 in another user interaction sessions 145. For example, the command 145 may include a money amount (e.g., $50.00) that is different from the money amount (e.g., $100.00) that was previously transferred to another entity in conjunction with a different user interaction session 144. In this way system 100 facilitates the entry of customizable commands 145 by a user 110 within the multiple-command macro 148 after which system 100 resumes with the next command 145 in the sequence of the macro 148. Other customizable commands 145 are indicated by column 308 of table 300. For example, after determining to transfer a money amount (e.g., $50.00), the system determines a default date to make the transfer (e.g., current date) which the user 110 may customize when executing the macro 148.

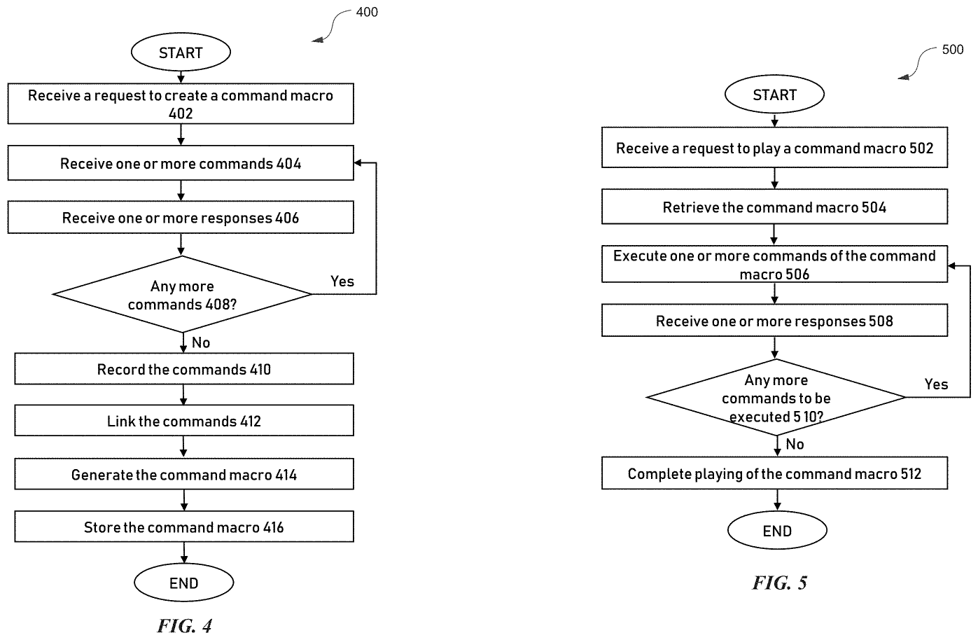

FIG. 4 illustrates an exemplary embodiment of a method 400 of generating a multiple-command macro 148, according to the present disclosure. The following is a non-limiting example that illustrates how the macro processing server 140 of system 100 implements method 400.

Upon starting the process, the server 140 receives a request 102 from a user 110 to create a multiple command macro 148 (step 402). For example, a user 110 may send a request 102 to the server 140 to generate a multiple-command macro 148, for example such as “Banking Autopilot.” In response to the request 102 to generate the macro 148, the server 140 may send a response 146 to the user 110 to confirm and start recording the commands 145 from the user 110 for generating the macro 148.

At step 404, the server 140 receives a series of commands 145 from the user 110 for requesting services from the server 140. For example, the commands 145 may include “show my balance,” “show my bills,” “send money to entity 1,” “show my grocery transactions for last month,” and “what's my FICO score?” Each of the commands 145 is associated with a timestamp 147. The commands 145 sent by the user 110 may have a text format or a voice format. In some embodiments where the commands 145 have voice formats, the server 140 may user a natural language processing (NLP) technique to understand the meaning of the voice command 145.

At step 406, in response to the series of commands 145, the server 140 sends a series of responses 146 to the user 110. Similar to the commands 145, the responses 146 provided by the server 140 may be also in the format of text or voice. For example, in response to the command 145 “show my balance,” the server 140 may play (e.g., display or speak) the account balances for the user 110. As another example, in response to the command 145 “show my bills,” the server 140 may play (e.g., display or speak) the outstanding bills for the user 110.

Execution proceeds to step 408 where the server 140 determines whether the user 110 sends more commands 145. If the server 140 determines that the user 110 has ended sending the commands 145, the process 400 proceeds to step 410. In some embodiments, the user 110 may provide a signal to conclude sending the commands 145 to the server 140 for the macro 148. For example, the user 110 may send a command 145, for example such as “save Banking Autopilot,” to the server 140 as a request 102 indicating that the user 110 has sent all commands 145 for the macro 148. If the server 140 determines that the user 110 is sending more commands 145, the process 400 proceeds back to step 404 and receives more commands 145 from the user 140.

At step 410, the server 140 records the commands 145 that were received form the user 110 if the server 140 determines that the user 110 has ended sending the commands 145. For example, the server 140 may store the commands 145 in the memory 143 of the server 140. Note that here the server 140 only records the commands 145 in the memory 143 such that the commands 145 are separated from the responses 146. In this way, the server 140 demarcates the commands 145 from the responses 146 when creating the macros 148 and stores only the commands 145 in the macros 148. The responses 146 from the server 140 may differ within different user interaction sessions 144. Therefore, storing the responses 146 in the macros 148 is unnecessary and requires extra memory space for storage. Storing only the commands 145 in the macros 148 facilitates conserving the memory space of the computers, thereby improving the performance of the computers and the overall system.

Furthermore, in some embodiments, the server 140 may only record key commands 145 from the user interaction session 144 into the macro 148. For example, the server 140 may records a subset of the commands 145 that are sent by the user 110. Referring to FIG. 2, among the commands 145 in column 204 of table 200, a subset of the commands 145, for example such as “show my balance,” “show my bills,” “send money to entity 1,” “show my grocery transactions for last month,” and “what's my FICO score?” are recorded in the macro 148 “Banking Autopilot.” The other commands 145 in column 204, for example such as the money amount and transfer date provided by the user 110, are not recorded in the macro 148 “Banking Autopilot” because such commands 145 may differ in different user interaction sessions 144. Storing these commands 145 in the macros 148 is unnecessary and requires extra memory space for storage. In some embodiments, the server 140 may compare the commands 145 provided by the user 110 to a number of pre-determined key commands 145 that are stored in memory 143. If a command 145 provided by the user 110 matches a pre-determined key command 145, the server 140 determines that the command 145 provided by the user 110 is a key command and records the command 145 in the macro 148. Furthermore, the server 140 may not record the commands 145 that include variables, for example such as a date or a money amount that may change in conjunction with user interaction sessions 144. The commands 145 that include such variables may not be considered as key commands 145 by the server 140. In alternative embodiments, a user 110 may specify the key commands 145 that will be recorded in the macro 148. For example, when providing a command 145 to the server 140, the user 110 may mark the command 145 as a key command 145 to request the server 140 to record the command 145 in the macro 148.

Referring back to FIG. 4, at step 412, the server 140 links together the commands 145 in sequence based on their timestamps 147. For example, a command 145 with the earliest timestamp 147 is placed at the beginning of the linked commands 145, and a command 145 with the latest timestamp 147 is placed at the end of the linked commands 145. For example, referring to FIG. 2, the server 140 may link together the commands 145 “show my balance,” “show my bills,” “send money to entity 1,” “show my grocery transactions for last month,” and “what's my FICO score?” in sequence based on their timestamps 147 such that the command 145 “show my balance” is the first command 145 and the command 145 “what's my FICO score?” is the last command 145.

Referring back to FIG. 4, at step 414, the server 140 generates the multiple-command macro 148 based on the linked commands 145. The macro 148 may include the linked commands 145 that are arranged in sequence based on their timestamps 147. For example, the macro 147 “Banking Autopilot” may include the commands 145 “show my balance,” “show my bills,” “send money to entity 1,” “show my grocery transactions for last month,” and “what's my FICO score?” that are linked together in sequence based on their timestamps 147.

At step 416, the server 140 stores the multiple-command macro 147. For example, the server 140 may store the macro 147 “Banking Autopilot” in the memory 143 of the server 140. The multiple-command macro 147 may be retrieved by the server 140 and played to execute the commands 145 in the macro 147 in sequence based on their timestamps 147. By generating a macro 147 that includes a series of commands 145, the system 100 only need to send a single web request 102 of the macro 147 instead of many web requests 102 of the commands 145 to the server 140 over the network 130. This approach reduces the number of web requests 102 that are transmitted over the network 130, thereby facilitating reducing the strain on the network 130 and alleviating the network bottlenecks.

FIG. 5 illustrates an exemplary embodiment of a method 500 of playing a multiple-command macro 148, according to the present disclosure. The following is a non-limiting example that illustrates how the macro processing server 140 of system 100 implements method 400.

At step 502, the server 140 receives a request 102 from a user 110 to play a multiple-command macro 148. For example, the user 110 may send a request 102 to the server 140 to play a multiple-command macro 148 that is stored in the memory 143 of the server 140, for example such as “Banking Autopilot.”

At step 504, the server 140 retrieves the macro 148 from the memory 143. For example, the server 140 may retrieve the commands 145 of the macro 148 that are stored in the memory 143 and prepare to execute the commands 145 in sequence based on their timestamps 147.

At step 506, the server 140 executes the commands 145 in the macro 148. Specifically, the server 140 executes the commands 145 in sequence based on their timestamps 147. In some embodiments, the server 140 may display the commands 145 that are played to the user 110 in the graphical user interface 141.

At step 508, the server 140 provides responses 146 to the commands 145. In some embodiments, when the server 140 plays the commands 145 and provides responses 146, the user 110 may interrupt the execution of the macro 148 and provide one or more additional commands 145. For example, referring to FIG. 3, when playing the command 145 “send money to entity 1” of column 304, the user 110 may provide a command 145 that indicates an amount of money that will be transferred to another entity. This command 145 may include a modification to a corresponding command 145 in another user interaction sessions 145. For example, the command 145 may include a money amount (e.g., $50.00) that is different from the money amount (e.g., $100.00) that was previously transferred to another entity.

Referring back to FIG. 5, at step 510, the server 140 determines whether every command 145 in the macro 149 has been executed. If the server 140 determines that every command 145 in the macro 148 has been executed, the process 500 proceeds to step 512. If the server 140 determines that there are one or more commands 145 in the macro 148 that need to be executed, the process 400 proceeds back to step 506 to execute the commands 145.

At step 512, the server 140 completes playing the macro 148 if the server 140 determines that every command 145 in the macro 148 has been executed. The server 140 may send an additional response 146 the user 110 indicating that the playing of the macro 148 is completed.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skill in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

What is claimed is:

1. A system for generating a multiple-command macro, comprising:
a memory; and
a macro processing server communicatively coupled to the memory and configured to:
perform a plurality of user interaction sessions, each of the user interaction sessions comprising:
a series of commands, each of the series of commands being associated with a timestamp; and
a series of responses in response to the series of commands;
in conjunction with performing a first user interaction session, receive a first request to generate a first command macro for the first user interaction session, the first user interaction session comprising a first series of commands and a first series of responses;
receive the first series of commands associated with the first user interaction session;
receive the first series of responses associated with the first user interaction session, the first series of responses corresponding to the first series of commands;
record the first series of commands such that the first series of commands are separated from the first series of responses;
link together the first series of commands in sequence based on their timestamps;
generate a first command macro comprising the linked first series of commands; and
store the first command macro in the memory.

2. The system of claim 1, wherein recording the first series of commands comprises:
receiving a first command of the first series of commands;
recording the first command;
in conjunction with the first command, receiving a first response of the first series of responses;
receiving a second command of the first series of commands; and
recording the second command such that the memory stores the first and the second commands in the first command macro but not the first response.

3. The system of claim 2, wherein the macro processing server is further configured to:
receive a second request from a user to replay the first command macro;
retrieve the first command macro from the memory, the first command macro comprising at least the first command and the second command; and
replay the first and the second commands of the first command macro in sequence based on the timestamps associated with the first series of commands in the first command macro.

4. The system of claim 3, wherein replaying the first and the second commands of the first command macro comprises:
executing the first command of the first command macro, the first command being associated with a first timestamp;
receiving a response to the first command from a server; and
in response to the received response, executing the second command of the first command macro, the second command being associated with a second timestamp that is later than the first timestamp.

5. The system of claim 4, wherein replaying the first and the second commands of the first command macro further comprises:
receiving a modification to the first command from the user; and
executing the first command with the modification.

6. The system of claim 1, wherein each of the first series of command comprises a text command or a voice command.

7. The system of claim 1, wherein each of the first series of responses comprises a text response or a voice response.

8. A non-transitory computer-readable medium comprising a logic for generating a multiple-command macro, the logic, when executed by one or more processors, instructing the one or more processors to:
perform a plurality of user interaction sessions, each of the user interaction sessions comprising:
a series of commands, each of the series of commands being associated with a timestamp; and
a series of responses in response to the series of commands;
in conjunction with performing a first user interaction session, receive a first request to generate a first command macro for the first user interaction session, the first user interaction session comprising a first series of commands and a first series of responses;
receive the first series of commands associated with the first user interaction session;
receive the first series of responses associated with the first user interaction session, the first series of responses corresponding to the first series of commands;
record the first series of commands such that the first series of commands are separated from the first series of responses;
link together the first series of commands in sequence based on their timestamps;
generate a first command macro comprising the linked first series of commands; and
store the first command macro in a memory.

9. The non-transitory computer-readable medium of claim 8, wherein recording the first series of commands comprises:
receiving a first command of the first series of commands;
recording the first command;
in conjunction with the first command, receiving a first response of the first series of responses;
receiving a second command of the first series of commands; and
recording the second command such that the memory stores the first and the second commands in the first command macro but not the first response.

10. The non-transitory computer-readable medium of claim 8, wherein the logic further instructs the one or more processors to:
receive a second request from a user to replay the first command macro;
retrieve the first command macro from the memory, the first command macro comprising at least the first command and the second command; and
replay the first and the second commands of the first command macro in sequence based on the timestamps associated with the first series of commands in the first command macro.

11. The non-transitory computer-readable medium of claim 10, wherein replaying the first and the second commands of the first command macro comprises:
executing the first command of the first command macro, the first command being associated with a first timestamp;
receiving a response to the first command from a server; and
in response to the received response, executing the second command of the first command macro, the second command being associated with a second timestamp that is later than the first timestamp.

12. The non-transitory computer-readable medium of claim 11, wherein replaying the first and the second commands of the first command macro further comprises:
receiving a modification to the first command from the user; and
executing the first command with the modification.

13. The non-transitory computer-readable medium of claim 8, wherein each of the first series of command comprises a text command or a voice command.

14. The non-transitory computer-readable medium of claim 8, wherein each of the first series of responses comprises a text response or a voice response.

15. A method for generating a multiple-command macro, comprising:
performing a plurality of user interaction sessions, each of the user interaction sessions comprising:
a series of commands, each of the series of commands being associated with a timestamp; and
a series of responses in response to the series of commands;
in conjunction with performing a first user interaction session, receiving a first request to generate a first command macro for the first user interaction session, the first user interaction session comprising a first series of commands and a first series of responses;
receiving the first series of commands associated with the first user interaction session;
receiving the first series of responses associated with the first user interaction session, the first series of responses corresponding to the first series of commands;
recording the first series of commands such that the first series of commands are separated from the first series of responses;
linking together the first series of commands in sequence based on their timestamps;
generating a first command macro comprising the linked first series of commands; and
storing the first command macro in a memory.

16. The method of claim 15, wherein recording the first series of commands comprises:
receiving a first command of the first series of commands;
recording the first command;
in conjunction with the first command, receiving a first response of the first series of responses;
receiving a second command of the first series of commands; and
recording the second command such that the memory stores the first and the second commands in the first command macro but not the first response.

17. The method of claim 15, wherein the method further comprises:
receiving a second request from a user to replay the first command macro;
retrieving the first command macro from the memory, the first command macro comprising at least the first command and the second command; and
replaying the first and the second commands of the first command macro in sequence based on the timestamps associated with the first series of commands in the first command macro.

18. The method of claim 17, wherein replaying the first and the second commands of the first command macro comprises:
executing the first command of the first command macro, the first command being associated with a first timestamp;
receiving a response to the first command from a server; and
in response to the received response, executing the second command of the first command macro, the second command being associated with a second timestamp that is later than the first timestamp.

19. The method of claim 18, wherein replaying the first and the second commands of the first command macro further comprises:
receiving a modification to the first command from the user; and
executing the first command with the modification.

20. The method of claim 15, wherein each of the first series of command comprises a text command or a voice command.
